(19) United States
(12) Patent Application Publication
(10) Pub. No.: US 2005/0256791 A1
(43) Pub. Date: Nov. 17, 2005

(54) System and method for administering charitable funds through affiliations of professionals

(76) Inventor: Benson L. Schaub, Phoenix, AZ (US)

Correspondence Address: KUNZLER & ASSOCIATES, 8 EAST BROADWAY, SALT LAKE CITY, UT, 84111, US

(21) Appl. No.: 10/846,879

(22) Filed: May 14, 2004

(51) Int. Cl. G06F 17/60

(52) U.S. Cl. 705/35; 705/38; 705/4; 705/1

(57) ABSTRACT

An affiliation of professionals administers charitable fund accounts. The membership of the affiliation contains tax and estate planning attorneys, and/or accountants, and/or CPAs, and/or other non-financial oriented professionals. The fund is created through the affiliation by one of the professionals working with a donor to select and fund the charitable fund. The charitable fund is administered by the management team of the affiliation. The administration involves managing an asset held under the charitable fund to produce a return on the asset. The return on the asset is distributed to a charity or income beneficiary depending if it's a charitable foundation or charitable trust. The donor exercises direction over the distribution of the return on the asset to charities. Any revenue generated through administration of the charitable fund by the management of the affiliation is placed in revenue pools. The revenue is apportioned to members of the affiliation according to the contribution of the respective members to the generation of the revenue.

### FIELD OF THE INVENTION

The present invention relates in general to charitable planning models and, more particularly, to systems and methods of establishing and administering charitable funds such as foundations and charitable trusts through the efforts and association of an affiliation of non-financial professional service providers.

### BACKGROUND OF THE INVENTION

Charitable organizations perform valuable services for society. Many people are in need of help at one time or another and greatly benefit from and appreciate the kindness and goodwill of others. Charitable organizations routinely give assistance to those in need in terms of money, materials, time, volunteer support, technical assistance, religious guidance, emotional comfort, safe haven, and counseling. Charitable organizations bridge the gap between government and public need, and do so with private funding operated with specific guidelines, principals, and accountability.

Most people follow strong moral, ethical, emotional, and spiritual callings and duty when deciding to give private financial assets, including monies, to worthwhile causes, people in need, and charitable organizations. The charity uses the private gifts to fund the organization according to their established mission statement and objectives. The private funding goes primarily to finance the charitable programs of the organizations and also to cover administrative expenses and costs of the organization. Some charities are set up to directly help the beneficiary by offering assistance in areas such as education, health care, homeless, abuse prevention, disaster relief, veteran programs, historical preservation, arts, wildlife, youth development, and environment. Other charitable organizations are set up solely to accumulate private funding and then distribute the funds to the charities that provide the direct assistance.

One operating principal that distinguishes different types of charities is the method of collecting and distributing the funds. One type of charity, sometimes called a “pass through” charity (i.e., the United Way), receives private funds and then distributes most, if not all, of the money remaining after administrative expenses have been deducted. For example, a charity may receive $100 from a donor. The gift is placed in a general fund. The charity deducts its expenses, which can be in the range of 40% or more, and then distributes the remaining money to one or more beneficiaries or recipients that merit support in accordance with the charity's purpose. The charity administration, often made up of a volunteer board of directors, decides when and to whom the money is allocated. Once the $100 has been distributed, the gift is gone and the charity again looks for another donor.

The pass through charity model depends on a continuous source of benefactors. Many times the benefactors are single event donors. That is, the donor gives a one-time gift through work or their place of worship. One of the reasons that administrative costs are so high with “pass through” charities is the significant resources that must be dedicated to fund raising. The success of fund raising efforts is often a function of the economy and personal circumstances. At certain times donors may have more discretionary money than other times. Yet, without a continuous influx of donations, the “pass through” charities' general funds quickly deplete. The lack of preservation of capital is an inherent weakness with the “pass through” charity model and represents an unattractive reality to many charities and donors alike.

Another significant concern among donors is the lack of control with respect to the distribution of the charity's assets. Since it is the charity administration that decides when and who receives money, there is little or no input or direction from the donor when such decisions are made. In many cases, the donor is unaware of the charitable distribution decisions. The beneficiary may be an organization which the donor philosophically opposes. From the donor's viewpoint, the “pass through” charity has the disadvantage of lack of donor direction in the allocation of funds.

Without the donor's participation, the charity must be thoughtful in its distribution decisions. In an effort to avoid negative publicity and not wanting to alienate donors, many charities choose to avoid controversial beneficiaries. Many worthwhile causes, depending on one's point of view, may go underfunded or have difficulty receiving money from mainstream organizations. These controversial affiliations must operate their own fund raising initiatives, which again increases administrative costs.

Another form of charity, which addresses some of the shortcomings of the “pass through” charity model, is an endowment or trust-based charity. These types of charitable accounts are now more commonly known as foundations, family foundations, donor advised funds, or donor directed accounts, hereinafter referred to as a foundation or foundation account. Examples of such funds include donor advised funds at a community foundation; donor accounts at a financial institution gift fund such as Fidelity Gift Fund or Vanguard Charitable Endowment Program; and a family foundation account at a national public charity that offers component family foundation accounts.

As a further example, a high net worth donor may establish a foundation. The principal capital of the foundation is invested, and the proceeds are distributed according to the guidelines or under the directions of the donor. The original capital is preserved. By distributing only the proceeds of the investments, and possibly a small portion of the original capital, the foundation provides a long-term, ongoing source of funding to charitable beneficiaries in accordance with the wishes of the donor. The beneficiaries come to rely upon the foundation funding and can offer more consistent and stable programs.

The charitable foundation or trust can be established with the assistance of a financial planner, who in turn engages the necessary professionals, e.g. lawyers, accountants, and bankers. The professionals receive their fees for specific services provided and the charitable fund is then administered by the foundation administration or trustee. Depending on the professionals involved, charitable funds can be complex and expensive to administer. Each plan may be different, which can lead to inconsistent, unpredictable results, and may not necessarily achieve the original objectives, especially after the donor is gone. Although financial planners generally may lack expertise in tax and legal aspects of foundation planning, in many cases they continue to serve as the point person if for no other reason then that they want the ongoing business that is generated annually in a charitable foundation or trust. The professionals with the most experience and knowledge, i.e. the tax and estate planning attorney who created the foundation plan, or the accountant who recommended the foundation plan, are generally not involved in the administration or ongoing business of the plan, in part, because such activities are outside their core practice area and there is little or no incentive to do so. The tax and estate planning attorney, or accountant lacks the framework to make the administrative tasks efficient and cost effective. Significant business related revenues are generated through the ongoing investments of the charitable foundation or trust. Also wealth replacement life insurance is often used in foundation planning. This invention allows for Attorneys, Accountants, and other Non-financial oriented professionals to effectively provide financial services to their clients and to be compensated for their efforts.

### SUMMARY OF THE INVENTION

In one embodiment, the present invention is a method of administering charitable funds. In certain embodiments, the method comprises the steps of organizing a affiliation or affiliation of professionals, such as members of a cooperative or business venture, that includes non-financial oriented professionals, creating charitable foundations, or charitable trusts through the affiliation by one of the plurality of professionals working with a donor to select and fund one of the above described charitable funds, administering the charitable fund through the management of the affiliation, generating revenue to the affiliation through administration of the charitable funds by the management of the affiliation, and apportioning the revenue to the members of the affiliation.

In another embodiment, the present invention is a method of forming an affiliation of professionals for the administration of charitable funds comprising the steps of providing a first fund under a first jurisdiction, administering charitable funds (including component family foundation accounts and affiliated foundation accounts), within the first foundation or that will in the future fund the foundation, generating revenue for the affiliation through administration of the charitable funds by the management of the affiliation, and apportioning the revenue to members of the affiliation of professionals.

### BRIEF DESCRIPTION OF THE DRAWINGS

FIG. 1 illustrates the relationship between donors and the charitable funds;

FIG. 2 illustrates the relationship between the donor, the professional service providers and the affiliation;

FIG. 3 illustrates a structural organization of the affiliation;

FIG. 4 illustrates a plurality of revenue pools for organizing profits of the affiliation; and

FIG. 5 illustrates the method of administering charitable funds.

### DETAILED DESCRIPTION OF THE DRAWINGS

Charitable giving is an important and noble function of modern society. Many worthwhile organizations exist primarily on the donations and contributions from donors. These charitable organizations routinely give assistance to those in need in terms of money, materials, time, volunteer support, technical assistance, religious guidance, emotional comfort, safe haven, and counseling. People in need of help greatly benefit from and appreciate the kindness and goodwill of others. The gifts can be used to provide assistance in areas such as education, religious programs, health care, international support, peace efforts, homeless, abuse prevention, disaster relief, veterans programs, historical preservation, youth development, arts, wildlife, and environment.

Charitable organizations routinely rely on the generosity and philanthropy of individuals and families and from for-profit and non-profit organizations. Many individuals and families of moderate to high net worth look for optimal instruments and methodologies of giving back to the community and those less fortunate. The instruments and methods used to make donation and gifts are considered and evaluated in terms of their efficiency and effectiveness of transferring money and other resources to the charity, and further to maximize the lawful tax benefit to the donor. The same is true for business organizations wishing to participate in philanthropy to important and worthwhile causes.

Many donors find it desirable to preserve the original capital contribution and distribute all or a portion of the proceeds of the invested capital. In doing so, the gifts to the charity or charities keep repeating year after year. In addition, most donors want to practice and maintain some control or direction over when, how, and to whom the gifts are distributed.

Philanthropic plans known to meet most if not all of these goals are referred to herein as “charitable funds.” These include endowments and charitable trusts or, more specifically, charitable family foundations (which include private foundations, component “donor advised” or “donor directed” accounts of Public Charities or community foundations, or family foundation accounts in national umbrella type public charity foundations), and charitable trusts or other gift plans intended to fund such foundations. In the charitable fund, the donor, operating under the name of the family, funds a charitable fund with an endowment of private capital. The fund is managed and invested to generate income. The income from the investments of the fund is distributed to charitable beneficiaries under the direction of the family or donor if it is a charitable foundation. The income from the fund goes to the charity of donor's choice, yet the fund's principal capital is preserved. In some circumstances, some of the fund's principal may be distributed as well, but the more typical objective is to continue the family foundation in perpetuity. The charitable family foundation encourages, promotes, and facilitates what some call “the privatization of philanthropy.” The donor may also become an income beneficiary if a charitable trust is established. Most charitable trusts or gift plans eventually fund a foundation or are otherwise gifted directly to charities.

These types of charitable funds have a number of tax advantages for the donor. Donors typically want to avoid estate tax and capital gains tax; they would rather the money go to the charity than the government. Depending on the plan and the present state of the tax laws, the fair market value of the original capital contribution can be partially or entirely tax deductible. In the case of appreciated property or assets, the charitable trust may partially or completely avoid capital gains tax. The tax consequences is an important consideration for donors in selecting the best plan both in terms of efficient transfer of wealth and maximizing the benefit for the donor. The charitable fund is an effective tool for practicing philanthropy.

A number of variations of the charitable fund are available to the donor. For example, a “family foundation income trust,” also known as a charitable remainder trust, provides the donor an income stream for life, and upon death the remainder is transferred to the family foundation. A “family foundation gift annuity” transfers an asset to the family foundation from the onset and then provides an income stream to the donor for life. There exist thousands of such foundations with assets in the billions of dollars.

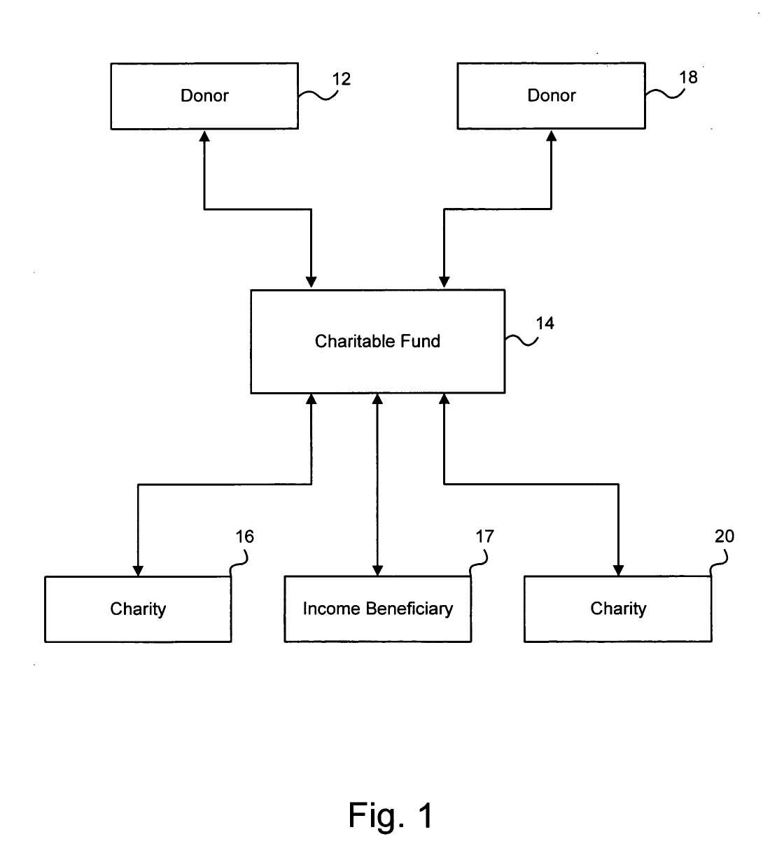

Referring to FIG. 1, a donor 12 contributes assets to a charitable fund 14. Donor 12 is typically a moderate to high net worth individual or family. Donor 12 can be a profit or non-profit organization wishing to initiate a philanthropic program. The assets contributed to foundation 14 can take the form of cash, cash-equivalents, securities, investments, equitable interests, real property, personal property, intellectual property, trusts, royalties, future income, lottery winnings, and almost any other asset having value.

The assets contributed by donor 12 are placed in charitable fund 14. Charitable Fund 14 is a legal instrument created to hold, maintain, manage, and administer the assets of the charitable fund as a qualified public charity under the applicable federal and state laws. Charitable fund 14 is overseen by a plan administrator, trustee, or management team. Investment professionals of the fund 14 invest and manage the assets with the intent to generate income and maximize the return on the assets, within the risk tolerance of the fund plan and charter. In most cases, the original assets are preserved in the fund, and the proceeds are distributed to charity 16 or to income beneficiary 17 in accordance with the donor's objectives. Charity 16 and income beneficiary 17 are intended to be a generic designation. The specific benefactor of charity 16 may change from time to time depending on the plan's objectives and the donor's direction. Foundation 14 preserves the capital to continue the long-term, ongoing benefit to charity 16. Donor 12 maintains a level of direction over the charitable distributions of the charitable fund either directly or through testimonial, to the extent permitted by the federal and state laws which control the foundation.

As shown in FIG. 1, donor 12 interacts with fund 14. For example, donor 12 makes an initial capital contribution to establish the fund and may make supplemental contributions. Donor 12 further provides direction as to the plan's charitable distributions. Fund 14 generates reports back to donor 12. Charity 16 also interacts with foundation 14. Foundation 14 communicates with charity 16 to understand its needs and distributes the proceeds of the foundation. Charity reports back to foundation 14 on how the funds have been utilized.

FIG. 1 further illustrates the embodiment of donor 18 contributing to fund 14, and fund 14 making distributions to charity 20. Accordingly, fund 14 can be organized to deal with a single donor operating a single charitable fund, or with a single donor operating multiple charitable funds, or with multiple donors operating multiple individual charitable funds, or with multiple donors contributing to a charitable fund. Foundation 14 is certainly capable of distributing from a single charitable fund to multiple charities, or from a portfolio of charitable funds to multiple charities.

The charitable fund can be an involved and sophisticated instrument, depending on the size of the fund, control of the donor, and objectives of the fund. It is important that the fund instrument comply with all federal and state laws to ensure its continued purpose and benefit for the donor, foundation, and charity beneficiary alike. The fund instrument should be created and confirmed by competent attorneys, accountants, and other financial and tax professionals.

In the past, the attorney and accountant may have participated in creating the fund instruments and related documents, but have rarely participated in the marketing of such plans or in the administration of the plan after the fact. Attorneys and accountants are an untapped resource of client contacts, and have lacked the framework from which to become more involved in charitable funds from conception to expiration. The administration of charitable funds is typically outside of the core practice areas of many tax and estate planning attorneys and accountants. Historically, they have had no incentive to get involved in such activities.

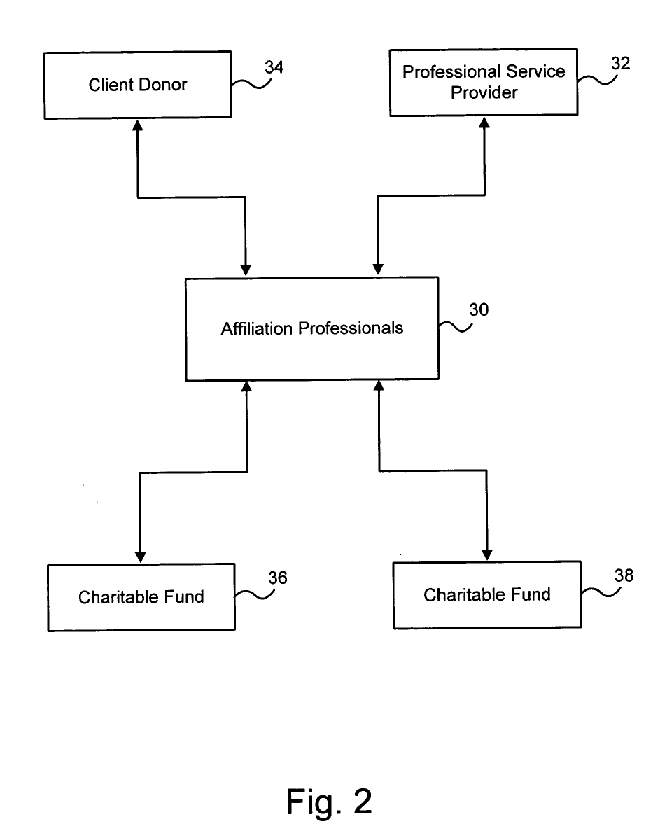

Turning to FIG. 2, affiliation 30 is established to bridge the gap between donors, their trusted professionals, and charitable funds. Affiliation 30 is a membership-based organization or collective of professional service providers which includes the management team of the affiliation. For instance, affiliation 30 may comprise a group, a cooperative, or a business organization such as a partnership (where appropriate under state bar ethical rules), a C-corporation, an S-corporation, an LLC, etc.

Many attorneys have relationships with individuals, families, and corporations who are interested in participating in philanthropic plans. These attorneys may practice tax law or estate planning law and may have the expertise to create charitable funds, but have generally lacked the time, inclination, motivation, and framework to do much else with these instruments; they are busy with their own practices. Accountants trained in tax and estate planning are in a similar position. Professional service providers 32 is a affiliation of people such as attorneys, and/or accountants, and/or other professionals with knowledge in the area of taxation, estate planning, and formation and administration of charitable funds or otherwise are in constant contact with or work with those who have accumulated wealth. Professionals 32 have relationships with clients of moderate to high net worth and other companies who could be interested in establishing charitable funds for private philanthropy. Client donor 34 represents the affiliation of such clients having existing or potential relationships with professionals 32.

Affiliation 30 works with or manages one or more parent, affiliated, or subsidiary foundations, each operating as a qualified public charity. These foundations are established under applicable law to qualify for public charity treatment. Affiliation 30 operates a variety of tax-beneficial philanthropy or gift plans (e.g. charitable remainder trusts, charitable gift annuities, charitable lead trusts, charitable life estates, etc.) The foundation plans are tried and proven to comply with the applicable laws and to effectively and efficiently manage and administer the assets of the fund to meet the objectives of the donor and serve the beneficiaries of the plan.

Affiliation 30 recruits professionals 32 to join as members to participate in the activities of the affiliation. Affiliation 30 gets professionals 32 involved in the conception, marketing, management, administration, and distribution of charitable funds. Affiliation 30 provides an organization and framework to properly and legally market and create charitable funds and then effectively and efficiently manages and administers the fund for the benefit of client donors 34 and the beneficiaries of the funds. Affiliation 30 unites otherwise isolated and disjointed professionals 32 with a well-organized and attractive platform to market and administer the charitable funds that they might have created, but would otherwise have become removed from the administration after the fact. As a member of affiliation 30, professionals 32 can offer client donors 34 an established, proven, comprehensive plan and organization with confidence that the donor's wishes and objectives will be carried out as intended for the life of the plan.

Affiliation 30 targets professionals 32 having good reputation, special competence, and established client base that could benefit from family foundation planning. Other professionals 32 can apply at will. Affiliation 30 considers the membership of each applicant based on the person's expertise, experience, performance, reputation, client base, and other factors weighing to overall benefit and bring synergy to the collective. Applicants approved by the acceptance committee become members of affiliation 30.

Once a member of affiliation 30, professional 32 may recommend, advise, and counsel client donor 34 to participate in one or more of the charitable funds or other foundation plans offered by the affiliation or foundation managed by the affiliation. It is understood that professional 32 would make such a recommendation if, and only if, the proffered plan is in the best interest of client donor 34. Professional 32 educates and advises client donor 34 with the various plans available through affiliation 30, as well as other philanthropic plans outside the affiliation that could benefit the client. Client donor 34 makes his or her own decision whether to engage in one or more of the charitable plans offered by affiliation 30, and which plan best suits their objectives in terms of charitable giving, control, tax benefits, transfer of capital, and preservation of capital.

Client donor 34 establishes charitable fund 36 through affiliation 30, with the guidance and assistance of professional service providers 32. In addition, client donor 34 may create another charitable fund 38 through affiliation 30, again with the assistance of professional service providers 32. Alternatively, another client may establish another charitable fund using the affiliation's management team 30 through professional service provider 32. In yet another embodiment, several client donors 34 may contribute to a common charitable trust fund or affiliation plan operated by affiliation 30. In general, one or more client donors 34 may use the affiliation's professional service providers 30 to create one or more charitable trusts or family foundation plans 36 and 38, or any combination thereof, all through affiliation 30. In other words, affiliation members 32, under the program of the affiliation 30, introduce their client donors 34 to the benefits of the affiliation and its charitable plans and, if there is a match, the client donors establish charitable funds through the affiliation.

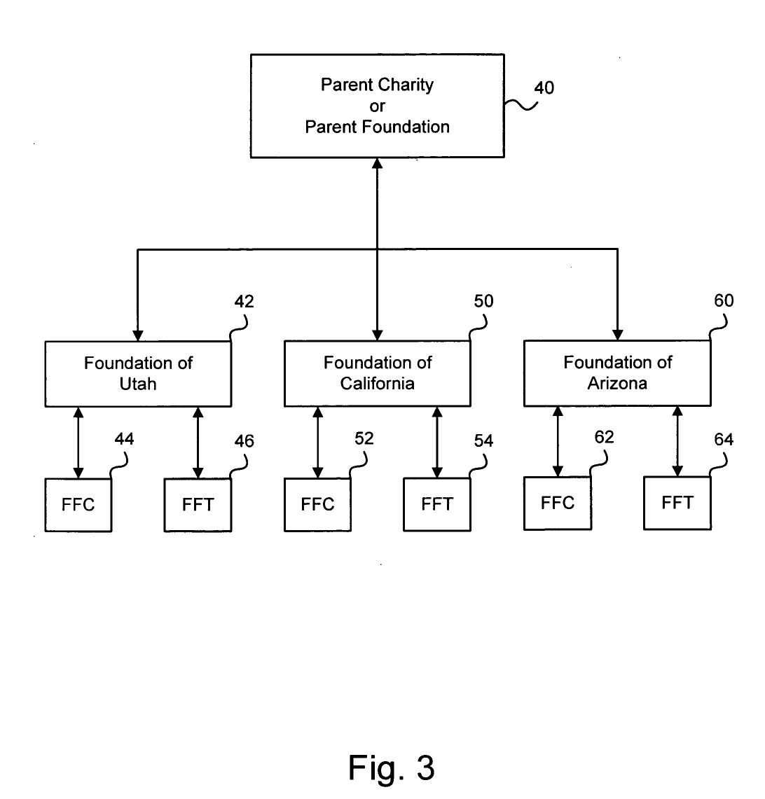

The structure of parent foundation 40 is shown in FIG. 3. In one embodiment, Parent Foundation 40 includes a plurality of affiliated or subsidiary foundations, each operating as a qualified public charity. Each state or sovereign jurisdiction may have its own foundation 42, 50, 60 which is a non-profit organization, qualifying as a public charity, which provides a variety of foundation gift plans and related charitable funds. For example, foundation of Utah 42 is an affiliated or subsidiary foundation of the parent foundation 40 with an operating structure specifically compliant with the laws of the State of Utah. As described above and through foundation of Utah 42, professionals 32 practicing in Utah establish charitable funds such as family foundation components (FFCs) and family foundation charitable trusts (FFTs) 44 and 46 through affiliation 30 for the benefit of client donors 34. Likewise, Foundation of California 50 is an affiliated or subsidiary foundation of the parent foundation 40 with an operating structure specifically compliant with the laws of the State of California. Through Foundation of California 50, professionals 32 practicing in California establish charitable funds such as FFCs and FFTs 52 and 54 for the benefit of client donors 34. Foundation of Arizona 60 is an affiliated or subsidiary foundation of the parent foundation 40 with an operating structure specifically compliant with the laws of the State of Arizona. Through Foundation of Arizona 60, professionals 32 practicing in Arizona establish charitable funds such as FFCs and FFTs 62 and 64 for the benefit of client donors 34. Such foundations 42, 50, 60 may be organized for every state.

In another sense, the affiliated or subsidiary foundations of each state are managed by individual affiliations operating under applicable state law, with an association to the common collective of affiliations and each state foundation receives support from the parent foundation 40.

Each affiliated or subsidiary foundation or each affiliation works with member professionals 32 to provide well-established, effective, and efficient charitable trusts and foundation plans for client donors 34. Member professionals 32 bring client donors 34 to the affiliation 30 to participate in its programs. If the affiliation's programs are in-line with their objectives, client donor 34 signs up to one or more foundation plan.

Member professionals 32 through the affiliation 30, may remain active in the management and administration of the foundation plans. Member professionals 32 serve on committees, evaluate performance, review reports, attend training, and support other functions for the benefit of the collective. Affiliation 30 may use investment committees, contract management, marketing committees, and member acceptance committees staffed by member professionals 32 to help run the business of the affiliation. The active participation by member professionals 32 with special knowledge and experience in charitable funds is beneficial to the affiliation's long-term success.

Once the charitable funds are established for the client donors, the assets contributed to the charitable fund are invested or otherwise managed so as to maximize the return and financial benefit for the purpose of the respective fund plan, which works for the beneficiary of the fund. The charitable fund, under affiliation's management, generates returns or proceeds from investment returns, trading securities, commercializing property, collecting rents and royalties, etc. Part or all of the after-expense-returns derived from the asset held under the foundation plan are distributed to one or more charitable organizations in-line with the client donor objectives, directions, and wishes, or in the case of a trust, are distributed to the donor or other income beneficiary.

A portion of the proceeds derived from management of the trust assets is properly channeled to the affiliation 30 in consideration of services provided and constitutes revenue or profit to affiliation 30. The revenue can arise from trust management fees, commissions on insurance, investment advisory fees, brokerage fees, mortgage fees and other support functions. Affiliation 30 organizes income and profits into revenue pools related to or associated with the source of such revenue.

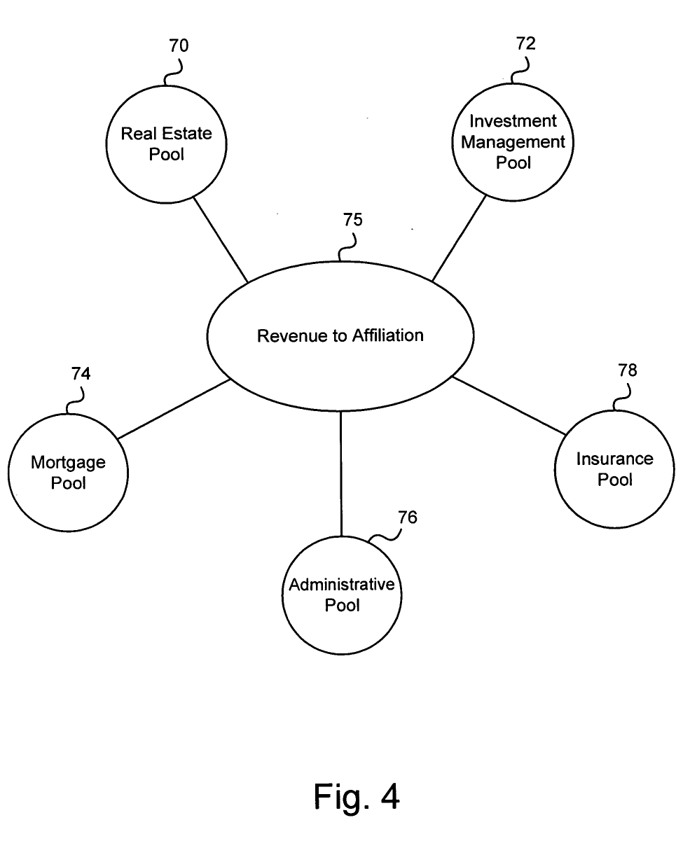

As shown in FIG. 4, affiliation 30 may form real estate pool 70, investment management pool 72, mortgage pool 74, administration pool 76, and insurance pool 78. From time to time, the profits in revenue pools 70-78 are distributed to the members of affiliation 30 by an agreed process and formulation. Member professionals 32 having brought client donors 34 to affiliation 30 who in turn establish charitable funds related to one or more of the revenue pools 70-78 are compensated for their contribution and participation to the success of the affiliation.

For example, if a first professional 32 brings a first client donor 34 and sets up a charitable fund funded with a real estate asset, then a certain amount of the commissions generated by the sale of the real estate-based part of the charitable fund is placed in real estate pool 70. Likewise, if a second professional 32 brings a second client donor 34 and sets up a charitable fund funded with investment-type assets, and again that the investments of a particular fund is managed by the affiliation, then the agreed upon investment advisory fee or other compensation is placed in the investment management pool 72.

At the time of distribution of profits from the revenue pools, the first and second professionals are fairly compensated in accordance with their contribution and for the assets which they brought to the affiliation. Revenue pools 70-78 allow for equitable distribution of the profits of affiliation 30 so that members are compensated in a manner consistent with their contribution.

The distribution of profits from the revenue pools can be customized to meet the changing needs of affiliation 30. A portion of the profits from the revenue pools 70-78 is set aside for facilities, staff, services, fees, equipment, marketing, advertising, promotions, special incentives, and other overhead expenses and administrative costs. A portion of the profits from the revenue pools 70-78 is reserved for the founding members of affiliation 30 to compensate for their vision and leadership. A portion of the profits from the revenue pools 70-78 goes to the managing member(s) or contract manager to compensate for their responsibility and administrative tasks. A portion of the profits from the revenue pools 70-78 may go to the top producing member(s) to compensate for their contribution above and beyond the norm. The remainder of the profits, which may be equal to, or in excess of, 75%, from the revenue pools 70-78 is allocated to the general members of affiliation 30 in a fair and equitable proportion to each person's contribution and value to the collective. The profits from the revenue pools 70-78 are apportioned to the members of affiliation 30 based on the respective contribution of the members to the business of the affiliation. If one of the revenue pools contains a significant portion of the overall profit, then the members with transactions in that particular revenue pool receive a commensurate allocation of the profit. The revenue pools provide an objective and equitable mechanism for allocating profits. The greater the quality and quantity of business that any professional 32 brings to affiliation 30, the greater the respective share of revenue generated through the affiliation.

Professionals 32 thus receive the incentive to actively participate in affiliation 30. The affiliation provides a quality product which is well-managed, and achieves the philanthropic objectives of client donor 34. Client donor 34 has confidence in the sophistication of affiliation 30, which is managed by professionals 32. Client donor 34 deals with the same people all the way through the process and avoids uncertainty of the legal effectiveness of unproven plans, and further saves document preparation fees and management costs, because the affiliation's foundation and trust plans are proven and well-established. Professional 32 stays involved in the long-term management and administration of the charitable fund. Professional 32 is no longer faced with merely preparing the trust documents and turning over trust management to others. Professional 32 can maintain the direct relationship with client donor 34 and be assured that the client's best interests continue to be served by the foundation plans. Professional 32 is compensated for the contribution and shares in the success of the business that they brought to the affiliation.

Many states and state bars have rules of professional conduct which govern and control different types of arrangements between attorneys, accountants, and other professionals. Each affiliation is compliant with the respective state laws and rules of the court, including conflicts of interest, fee splitting, attorney client relationship, and fiduciary obligations. Appropriate disclosure statements are made to client donor 34. Furthermore, affiliation 30 maintains and honors contractual obligations imposed on or by the participating member attorneys or accountants.

The affiliation's programs are all-encompassing for the benefit of professional 32 and client donor 34 alike. Affiliation 30 handles the marketing, plan structure, documentation, management, administration, reporting, and distribution. The efficient and effective management of the foundation plans are the cornerstone of the successful implementation of the client objectives. The effectiveness of the affiliation is realized through the network of cooperation among member professionals 32.

Affiliation 30 increases the level of uniformity and certainty among foundation plans and creates a standard of excellence in the foundation planning documents, administration oversight, and distribution strategies for the benefit of the donor and beneficiaries. The level of confidence in affiliation 30 makes donors want to give more with assurance that the assets will be well-managed, safe, and effective in carrying out the wishes of the donor, both in the present and posthumously. The donor creates a lasting legacy for the benefit of the donor's family and the many charities the donor and the donor's family want to benefit.

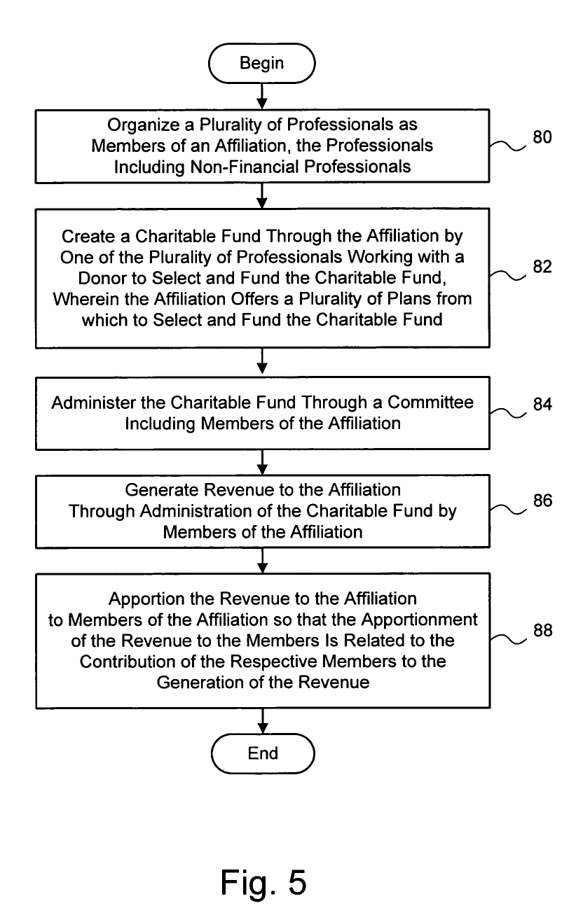

FIG. 5 illustrates the steps of administering charitable funds under the present invention. Step 80 organizes a plurality of professionals as members of a affiliation. The plurality of professionals preferably includes attorneys and/or accountants and may include other non-financial oriented professionals. Step 82 creates a charitable fund through the affiliation by one of the plurality of professionals working with a donor to select and fund the charitable fund. The affiliation offers a plurality of charitable funds from which to select.

Step 84 administers the charitable foundation and/or the charitable trust. This is preferably handled by the management team of the affiliation.

Step 86 generates revenue to the affiliation through administration of the charitable fund. The administration of the charitable fund preferably involves managing an asset held under the charitable fund to produce a return on the asset and distributing the return on the asset to a charity or to an income beneficiary. The revenue to the affiliation is allocated to a plurality of revenue pools related to the source of the revenue generation. The donor exercises direction over the distribution of the return on the asset to charities. The asset held under the charitable fund is substantially preserved.

Step 88 apportions the revenue to the affiliation to members of the affiliation. The apportioning of the revenue to the members is preferably made according to the contribution of the respective members to the generation of the revenue.

The charitable trust may be administered with the use of a computer program. The computer program may comprise a spreadsheet, database, or application configured to track and coordinate the various aspects of the charitable trusts originated through the cooperative, as well as calculating returns to cooperative members. In one embodiment, the computer program may be a modified financial program such as Quicken™, Money™, or PeachTree™. It may also be a custom generated program. The computer program is preferably selected or programmed to include investment modules.

The computer program is in one embodiment configured with a separate account for each family foundation component. Each of those accounts is set up on the program under an account number system connected with a brokerage attached to that account number. This allows each account to be segregated for reporting purposes back to the donors and also allows consolidated management of all of the accounts.

The invention also allows the downloading of information from numerous brokerage dealers. Additionally, the invention allows for the consolidation of family foundation accounts so that they can appear as one large investment portfolio for the foundation as a whole. Thus, the invention allows the reporting of both the individual donor's and the complete foundation's investment reports.

In addition to the component fund just described, each charitable organization may be provided with an individual file that can have multiple accounts. For example, a foundation may have, for example, over 100 different investment accounts held within it. The computer program may be configured to generate different separate reports for each of the donor accounts and to also consolidate those all into one report showing all the assets for the company.

For trusts, each of the trusts is input into the software program as a separate file so that each may be used to generate a separate tax return. Thus, a CPA may be provided with the ability to review and make any adjustments because he also receives duplicate copies of all the statements and transactions that are processed through the system. Consequently, at year end when it is time to prepare the returns for the trust, the CPA essentially can just export the information and load it right into the trust returns.

The computer program allows for the creation of combined account to more effectively manage the investments. This allows all of the donors for all of the component funds to invest either in our equity account or income account depending on the allocation for each fund. This, in turn, reduces the total number of broker-dealer accounts that must be dealt with, so that all of the assets of a large number of component funds and trust funds can be organized into two major investment types of accounts. The software allows the separation into a unit value of the amounts each component fund or trust has allocated to those funds. These values can be reported through the software program as segregated accounting for the donors.

A person skilled in the art will recognize that changes can be made in form and detail and equivalents may be substituted for elements of the invention without departing from the scope and spirit of the invention. The present description is therefore considered in all respects to be illustrative and not restrictive, the scope of the invention being determined by the following claims and their equivalents as supported by the above disclosure and drawings.

In addition, the computer program may also keep track of and calculate distributions of the affiliation's revenues to the members of the affiliation. Consequently, the program may be configured with an input module for receiving the contribution amount from each member and a calculation module to receive or calculate the amount that the relative funds have earned during a selected time period for which a distribution is to be made. An output module may also be provided and configured to display to an administrator the amount to be distributed to each of the affiliation members.

1. A method of administering charitable funds accounts, comprising:
organizing a plurality of professionals into an affiliation;
creating a charitable fund through the affiliation by one of the plurality of professionals working with a donor to select and fund the charitable fund;
administering the charitable funds;
generating revenue to the affiliation through administration of the charitable fund; and
apportioning at least a portion of the revenue of the affiliation to members of the affiliation.

2. The method of claim 1, wherein the affiliation comprises a cooperative.

3. The method of claim 1, wherein administering the charitable fund comprises administering the charitable fund through a management team that are members of the affiliation;

4. The method of claim 1, wherein the plurality of professionals comprises attorneys.

5. The method of claim 1, wherein the plurality of professionals comprises accountants and CPAs.

6. The method of claim 1, wherein the plurality of professionals comprises non-financial oriented professionals.

7. The method of claim 1, further comprising the affiliation offering a plurality of charitable fund plans from which to select.

8. The method of claim 1, wherein the step of administering the charitable fund further comprises the steps of:
managing an asset held under the charitable fund to produce a return on the asset; and
distributing the return on the asset to a charity or income beneficiary.

9. The method of claim 8, further comprising the donor exercising direction over the distribution of the return on the asset to the charity.

10. The method of claim 8, wherein the asset held under the charitable fund is substantially preserved.

11. The method of claim 1, wherein the revenue to the affiliation is allocated to a plurality of revenue pools related to sources of the revenue generation.

12. The method of claim 1, wherein the apportioning of the revenue to the members is related to the contribution of the respective members to the generation of the revenue.

13. The method of claim 1, wherein the step of administering the charitable trust comprises administering the charitable trust using computer program configured to treat each individual charitable trust as an individual account and as a member of a group of related accounts and to calculate a return on profits of the affiliation to individual members of the affiliation.

14. A method of administering a charitable fund, comprising:
creating a charitable fund through an affiliation of professionals, wherein one of the professionals works with a donor to select and fund the charitable fund;
administering the charitable funds through the affiliation of professionals;
generating revenue through administration of the charitable fund by the management of the affiliation; and
apportioning the revenue to members of the affiliation.

15. The method of claim 13, wherein the affiliation of professionals comprises attorneys.

16. The method of claim 13, further comprising the affiliation of professionals comprises accountants and CPAs.

17. The method of claim 13, wherein the affiliation of professionals comprises non-financial oriented professionals.

18. An arrangement for the administration of a charitable fund, comprising:
a first foundation existing under a first jurisdiction;
means for administering charitable funds within the first foundation;
means for generating revenue for the affiliation through administration of the charitable funds charitable funds by the management of the affiliation; and
means for apportioning the revenue to members of the affiliation of professionals.

19. The arrangement of claim 32, further comprises:
a second foundation existing under a second jurisdiction; and
means for administering the charitable funds within the second foundation.

20. The arrangement of claim 32, wherein the first foundation offers a plurality of charitable fund plans from which to select.

21. The arrangement of claim 32, wherein the means for administering the charitable fund comprises:
means for managing an asset held under the charitable funds to produce a return on the asset; and
means for distributing the return on the asset to a charity or income beneficiary.

22. The arrangement of claim 33, wherein the means for administering the charitable fund comprises a computer program configured to treat each individual charitable trust as an individual account and as a member of a group of related accounts and to calculate a return on profits of the affiliation to individual members of the affiliation.
